(19) United States
(12) Patent Application Publication
(10) Pub. No.: US 2025/0037621 A1
(43) Pub. Date: Jan. 30, 2025

(54) SYSTEMS AND METHODS FOR PROVIDING SENSING AND LIGHTING TO MAINTAIN REAL NOSE PERCEPTION IN VIRTUAL REALITY

(71) Applicant: Sony Interactive Entertainment Inc., Tokyo (JP)

(72) Inventors: Jeffrey Roger Stafford, Redwood City, CA (US); Todd Tokubo, Newark, CA (US)

(21) Appl. No.: 18/360,736

(22) Filed: Jul. 27, 2023

(51) Int. Cl. G09G 3/00; G02B 27/01; G02C 5/02; G06F 3/01

(52) U.S. Cl. CPC G09G 3/002; G02B 27/0176; G02C 5/02; G06F 3/012; G02B 2027/0178; G09G 2340/0435; G09G 2354/00; G09G 2370/02

(57) ABSTRACT

A wearable device is described. The wearable device includes a first display portion and a second display portion. The first display portion is located in front of eyes of a user to provide a high-resolution view of a virtual image of a virtual scene. The second display portion is located in front of the eyes of the user to provide a view of the user's nose. The second display portion can optionally occlude an area around the nose and optionally provide an effect of virtual lighting falling on the nose. The wearable device presents a view of the user's real nose as it would appear in a virtual scene.

### FIELD

The present disclosure relates to systems and methods for providing sensing and lighting to maintain real nose perception in virtual reality are described.

### BACKGROUND

Video games are a popular entertainment activity that players can engage in through the use of a video game console or a personal computer. In server-based gaming systems, video devices and personal computers can be used to receive input from an attached game pad, keyboard, joystick or other game controller, process video game software, and display video game images on a connected display device, such as a television or monitor or a head-mounted display.

The video game consoles and personal computers also can be used for multi-player games. In the multi-player games, each player uses different game controllers and different display devices that are coupled to the server-based gaming systems via the same game console or different game consoles. Sometimes, in the multi-player games, the video games do not appear engaging or appealing.

It is in this context that embodiments of the invention arise.

### SUMMARY

Embodiments of the present disclosure provide systems and methods for providing sensing and lighting to maintain real nose perception in virtual reality.

A virtual reality (VR) system provides a realistic view of a virtual scene such that a user, such as a person, perceives the virtual scene to be a real scene. For example, the virtual scene displayed to the user via a VR Head Mounted Display (HMD) system that the user wears, looks and behaves like a real scene view. The virtual scene appears to the user similar to the real scene view when the user is not wearing the VR HMD. Some VR systems achieve a good approximation of the real scene, through a combination of VR HMD optics, per-eye view rendering and tracking a pose, which includes a position and orientation, of the user's head in relation to the virtual scene, and updating the rendering accordingly. However, due to a fit of VR HMDs and the placement of the VR HMD optics, such as Aspheric lenses, Fresnel lenses, Pancake lenses, or waveguides, used to deliver a wide, immersive field of view, the VR HMD blocks the real view of the user's nose.

The user is aware of the nose in his/her vision, even though most of the time, the user's brain filters it out of a view of the user, especially when viewed with both eyes. The awareness of the nose is sometimes referred to herein as peripheral perception. The peripheral perception of the nose can help elevate a feeling of motion and provide some stability to a vision of the user. Rendering a virtual version of the nose in VR can provide a peripheral sense of stability when perceiving virtual motion, thus reducing any negative effects of virtual motion. The nose provides a grounding effect in people's vision. However, users have noses of different sizes and shapes and the different sizes and shapes fill in different portions of each user's inner field-of-view towards the nose of the user. Typically, VR HMDs display images at a fixed virtual image distance, such as around 2 meters, to allow most of the users to view the virtual scene comfortably. This differs from the real view of the nose, which being so close to the eyes of the user is extremely blurred, as the user cannot focus on it. The VR HMD optics can be moved to not bridge the nose, and thus provide a binocular view without blocking the user's view of their real nose. However, when the VR HMD optics are moved beyond the user's nose, the VR HMD becomes much bulkier than eye glasses or sunglasses that most people are used to wearing.

In an embodiment, an attempt to increase realism of the virtual scene, such as a VR scene, and provide the grounding effect for virtual motion, by actually showing the user's real nose through a gap in an occlusion layer, such as an optical occlusion layer, based on the user's real nose in his/her view in a wide FOV VR system is provided. For example, the occlusion layer is displayed on a small portion of a nose-side area, which is an area closest to the nose, of a VR device, such as a VR eyeglass or an HMD. The VR device has a clear aperture with the occlusion layer.

In one embodiment, the occlusion layer is dynamically adjusted when the user first wear's the VR device based on sensing a shape and size of the nose of the user from each side of the nose. The sensing of the shapes and sizes of the two sides of the nose is performed by one or more sensors, such as a low resolution depth camera, a low resolution infrared camera, or a low resolution red, green, and blue wavelength (RGB) camera. Additional examples of the sensors include a sensor that generates a low resolution image of the nose to provide to a processor. The processor executes a computer program to determine the shape and size of the nose, and an image of the shape and size is projected onto the VR device to form the occlusion layer from a perspective of the eyes of the user as the user looks towards the nose. As the real view of the nose is very blurry to the user, even to one with extreme myopia, a low resolution approximation of a silhouette of the nose is generated to determine an amount of change to apply to the occlusion layer. The occlusion layer is changed such that a blurry view of the nose is merged with a view of a VR scene and there is no light entering through the occlusion layer to the user's eyes for the VR scene. The occlusion layer has sufficient pixelated resolution to ensure tight coupling of the VR scene view and the real view of the nose. The transparent portions of the occlusion layer provide the real view of the nose.

In an embodiment, there are no additional focusing optics between the occlusion layer and the eyes of the user. Therefore, an optical occlusion effect of the occlusion layer in which light is actively blocked, will form a blurry edge between the VR scene and a see-through image of the nose of the user.

In one embodiment, the occlusion layer does not need to be dynamically refreshed at a real-time rate and is updated when the user puts on the VR HMD in front of his/her eyes.

In an embodiment, the sensors that are used to determine the shapes and sizes of the two halves of the nose are used to determine VR device slippage in which the VR device has shifted in relation to face and the eyes of the user. The computer program detects that the shapes and sizes of the two halves of the nose has changed from some initial state when the user first wears the VR device from the data output from the sensors pointing at the nose of the user. The shapes and sizes have changed from the initial state to another state due to the slippage, such as movement, of the VR device. The computer program updates the occlusion layer to account for the slippage. As such, the occlusion layer is updated infrequently and a low refresh, low power occlusion display technology, such as, for example, transparent Electronic Paper (E-Paper) or transparent electrochromic display, can be adapted. It should be noted that the VR device allows the user to see the real view of their nose, while also seeing a wide FOV view of the VR scene. However, virtual lighting from the VR scene will not be present on the view of the real nose.

In an embodiment, an additional lighting system is implemented to shine light that approximates virtual lighting from the VR scene onto the nose of the user. The user's nose is lighted or a simulation of light falling on the user' nose is provided. For example, a nose lighting system, such as small RGB light emitting diodes (LEDs) embedded in a nose bridge of the VR device that lights up the nose of the user, is provided. As another example, a VR waveguide optics system is provided. In the VR waveguide optics system, light from the VR scene is in-coupled at an edge of a VR waveguide lens bounces within a waveguide under conditions of total internal reflection (TIR) and exits the waveguide at an out-coupling area to the nose, roughly in a center of the VR waveguide lens. The VR waveguide lens is a lens of the VR device having an edge along which the waveguide is laid. An edge of the VR waveguide lens at which the in-coupling occurs is a side temple area of the VR device. The out-coupling occurs in the area next to the nose, and the out-coupling exits light emitted from the VR scene towards the nose. As yet another example, a wide FOV waveguide that out-couples light of the VR scene to the eye across an entire FOV of a lens of the VR device is provided. In this case, as a viewing region near the nose is not occluded by the occlusion layer, letting a view of the nose pass-through, light from VR scene delivered by the wide FOV waveguide is out-coupled and combined with an actual view of the nose. This combination, the same as an additive optical see-through augmented reality (AR), uses a virtual lighting image on the nose covering portion of wide FOV waveguide display to simulate the nose being lit by the VR scene. In the example, the occlusion layer is utilized to simulate an absence of light by partially blocking, using partial opacity, pass-through light from the nose. Therefore, in such a system, the occlusion layer dynamically updates up to a refresh rate of the VR scene to accurately reflect dynamic changes to the virtual lighting that would fall on the nose. As such, various VR devices provide the real view of the user's nose during VR sessions and maintain an illusion of perception that the user is seeing another real scene, thus increasing the user's feel of presence within the VR scene.

Some advantages of the herein described systems and methods include providing a real view of the nose of the user while viewing the VR scene via the VR device. For example, the occlusion layer is displayed on the VR device and an intensity level of the occlusion layer is controlled to be opaque or translucent. To illustrate, the occlusion layer is of a low resolution compared to the VR scene. As an illustration, the occlusion layer is not a VR image of the nose of the user. Also, the occlusion layer is generated based on an outline providing a shape and size of the nose of the user and by providing the intensity level to the occlusion layer.

Other aspects of the present disclosure will become apparent from the following detailed description, taken in conjunction with the accompanying drawings, illustrating by way of example the principles of embodiments described in the present disclosure.

### BRIEF DESCRIPTION OF THE DRA WINGS

Various embodiments of the present disclosure are best understood by reference to the following description taken in conjunction with the accompanying drawings in which:

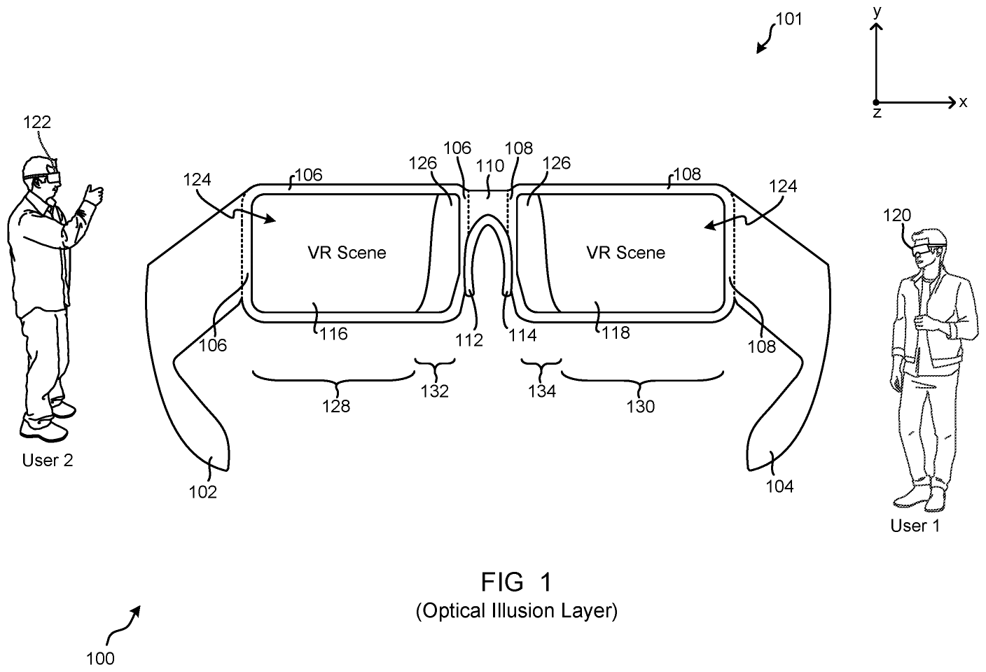

FIG. 1 is a diagram of an embodiment of a system to illustrate an occlusion layer as viewed from a rear view of a virtual reality (VR) system.

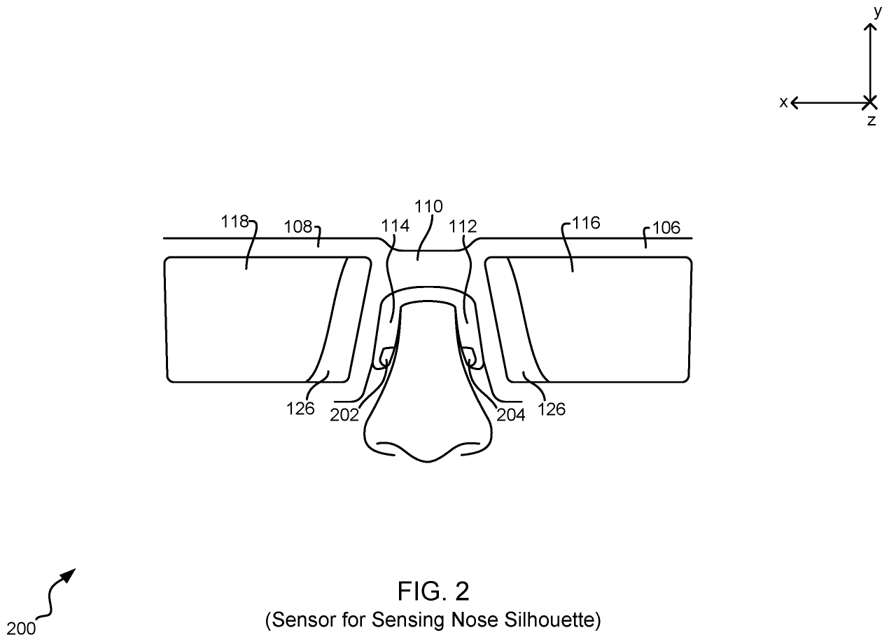

FIG. 2 is a diagram of an embodiment of a system to illustrate use of sensors to facilitate generation of the occlusion layer.

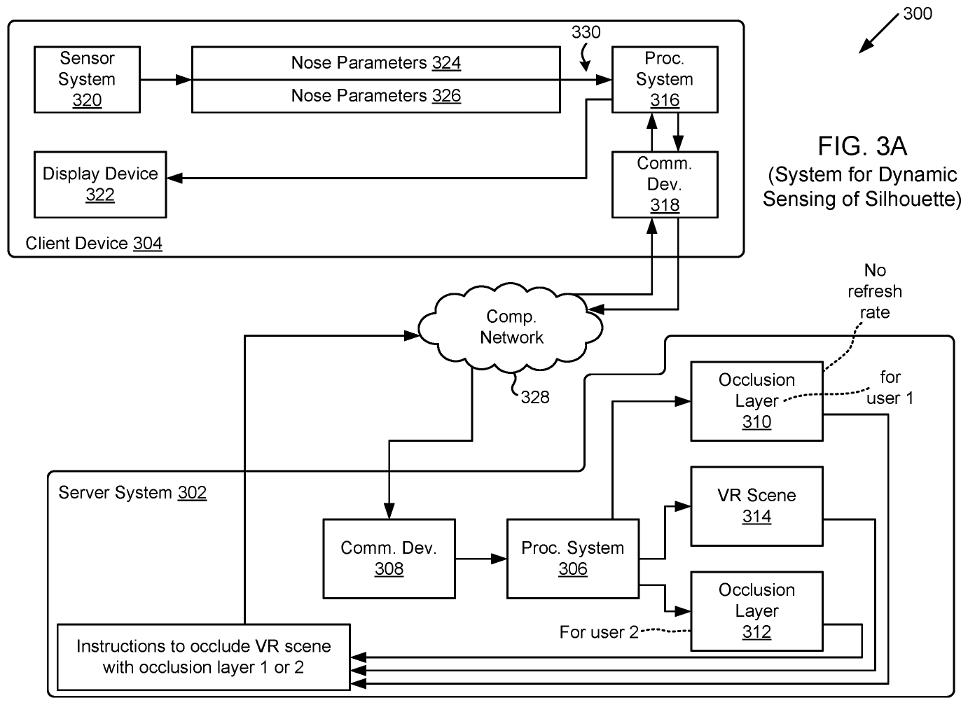

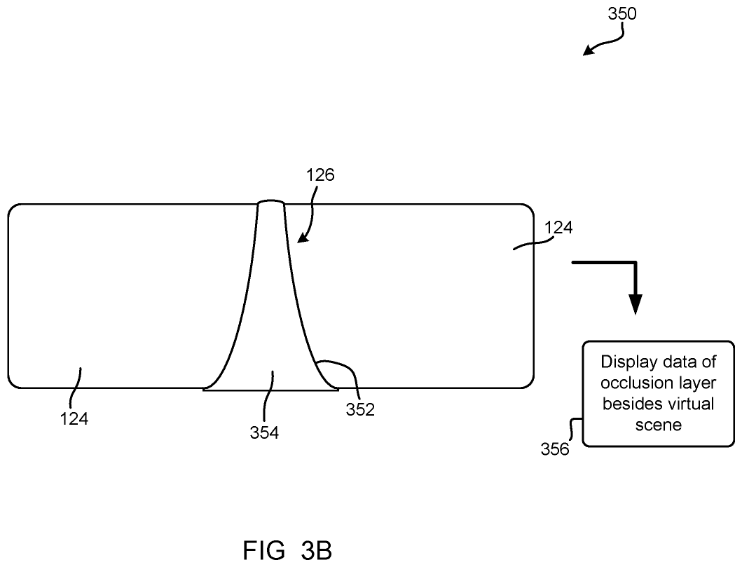

FIG. 3A is a diagram of an embodiment of a system to illustrate dynamic sensing of parameters of noses of different users.

FIG. 3B is a diagram of an embodiment of a system to illustrate generation of data of the occlusion layer and display of the occlusion layer besides a VR scene.

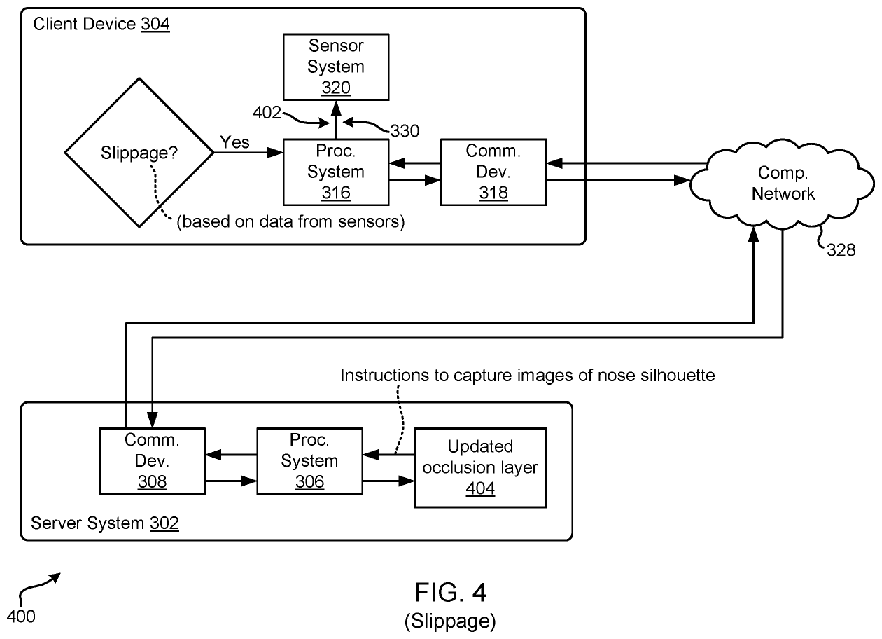

FIG. 4 is a diagram of an embodiment of a system to illustrate an occurrence of an update of the occlusion layer with slippage of the VR system on a nose of a user.

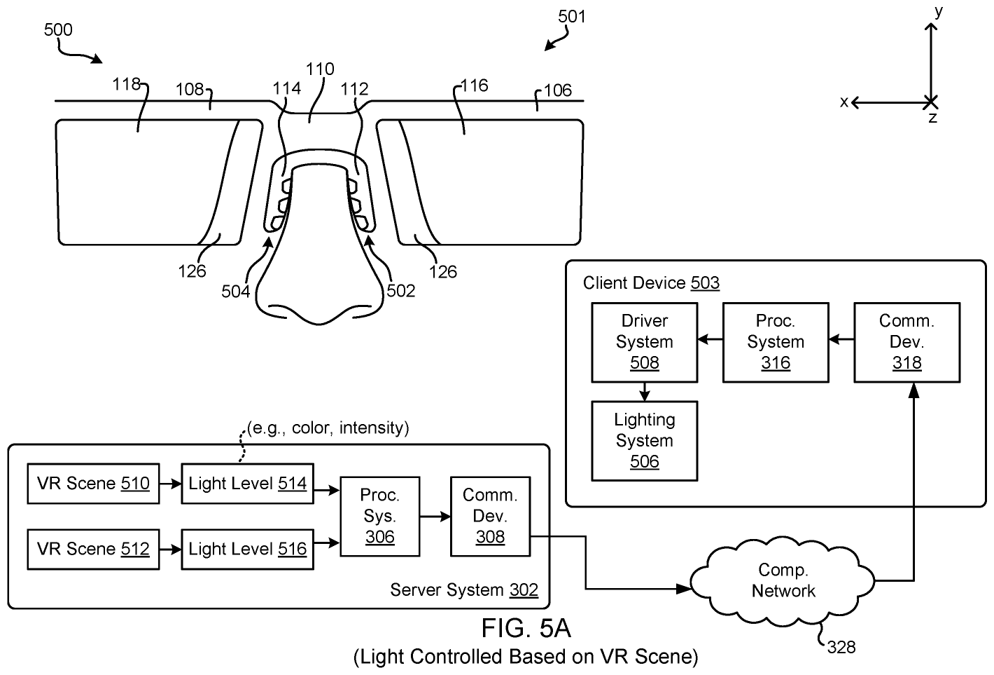

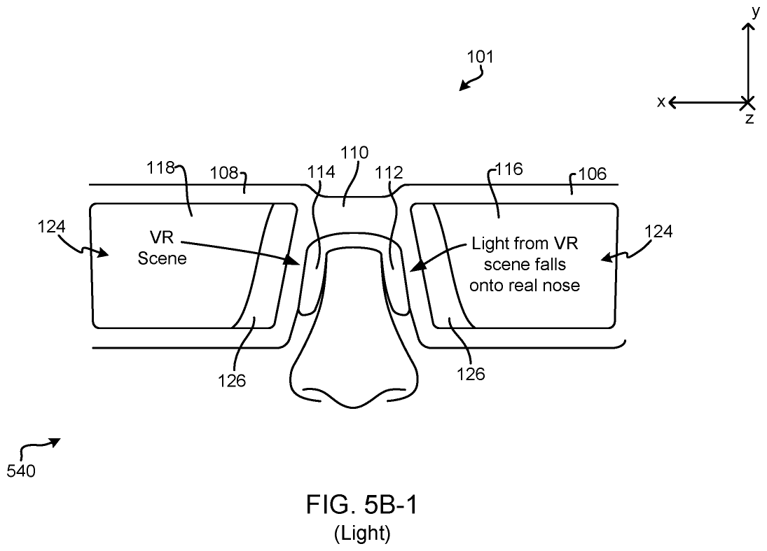

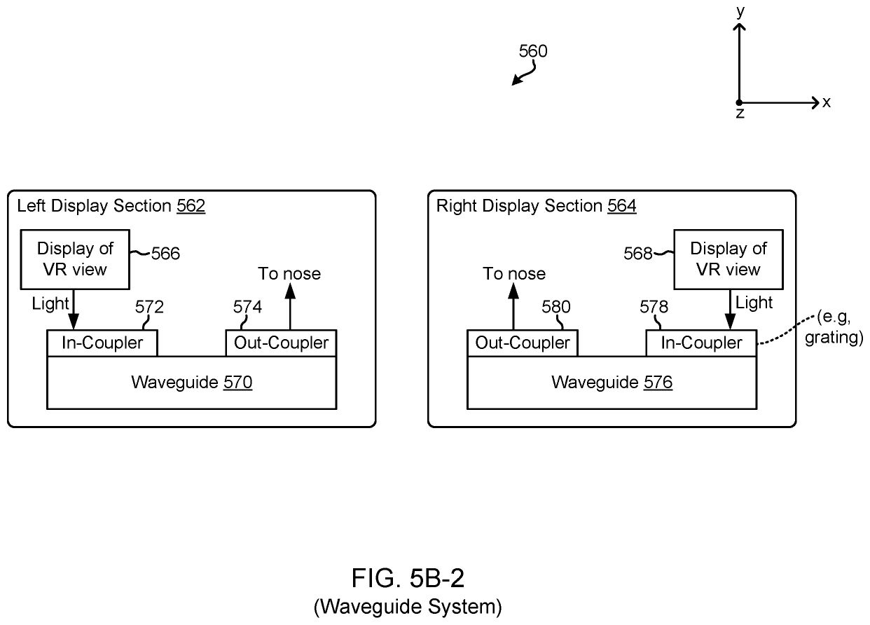

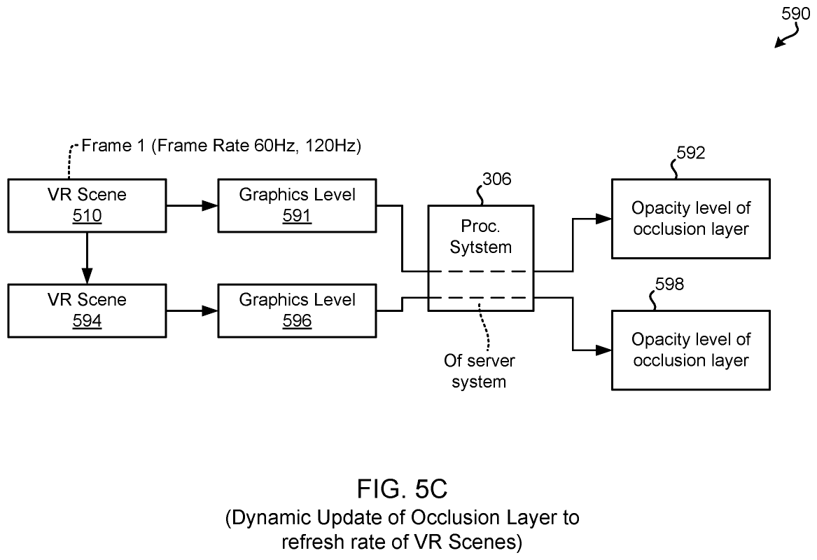

FIG. 5A is a diagram of an embodiment of a system to illustrate a lighting system for providing a realistic view of the nose of the user under virtual lighting from the VR scene.

FIG. 5B-1 is a diagram of an embodiment of a system to illustrate that light from a VR scene is incident via the occlusion layer on the nose of the user.

FIG. 5B-2 is a diagram of an embodiment of a VR system to illustrate transmission of light emitted from the VR scene via a waveguide to be incident on the nose of the user.

FIG. 5C is a diagram of an embodiment of a system to illustrate a dynamic update, such as a refresh, to the occlusion layer based on a refresh rate of the VR scene.

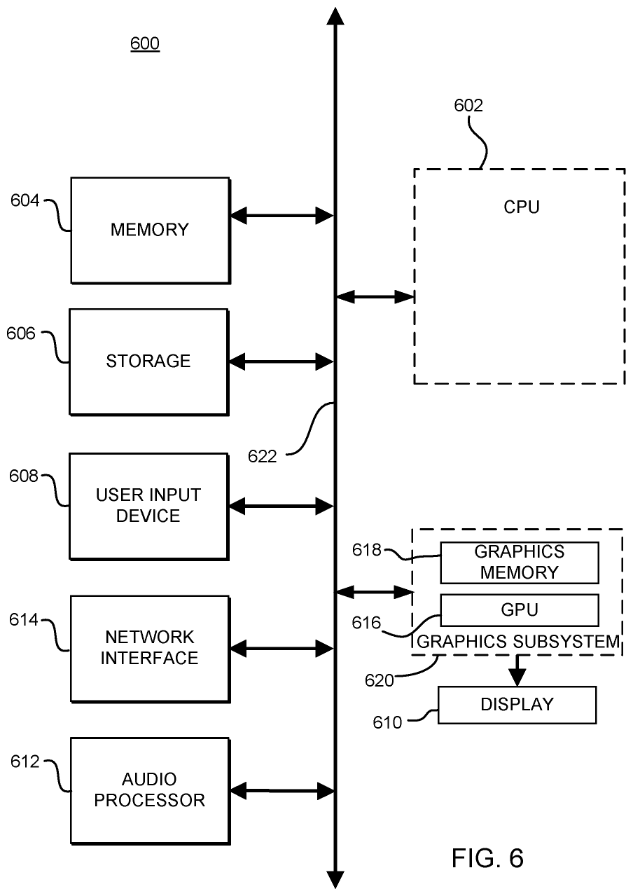

FIG. 6 illustrates components of an example device, such as a client device or a server system, described herein, that can be used to perform aspects of the various embodiments of the present disclosure.

### DETAILED DESCRIPTION

Systems and methods for providing sensing and lighting to maintain real nose perception in virtual reality are described. It should be noted that various embodiments of the present disclosure are practiced without some or all of these specific details. In other instances, well known process operations have not been described in detail in order not to unnecessarily obscure various embodiments of the present disclosure.

FIG. 1 is a diagram of an embodiment of a system 100 to illustrate a rear view of a virtual reality (VR) system 101. The rear view is from eyes of a user who wears the VR system 101. Examples of the VR system 101 include a head-mounted display (HMD), smart glasses, VR goggles, a VR headset, a VR visor or any near-to-eye display system to deliver VR images. The VR system 101 includes a left temple 102, a right temple 104, a left rim 106, a right rim 108, a nose bridge 110, a left nose pad 112, and a right nose pad 114. An example of a temple is an arm that is supported on and by an car of the user. Also, the VR system 100 includes a left lens 116 and a right lens 118. Each of the left lens 116 and the right lens 118 is an example of a display portion of the VR system 101. For example, the lens 116 includes a display screen and the lens 118 includes a display screen. A user 1 wears a VR system 120 and another user 2 wears a VR system 122. The VR system 101 is an example of any of the VR systems 120 and 122.

The left rim 106 is contiguous with and located next to the left temple 102. Similarly, the right rim 108 is contiguous with and located next to the right temple 104. Also, the each rim 106 and 108 is coupled to, such as integrated with, and contiguous with the nose bridge 110. The left rim 106 surrounds the left lens 116 and the right rim 108 surrounds the right lens 118. The rims 106 and 108 are coupled together via the nose bridge 110 that rests on a nose of the user. The left nose pad 112 is located at a side of and coupled to, such as attached with, the left rim 106 and the right nose pad 114 is located at a side of and coupled to, such as attached with, the right rim 108. The left nose pad 112 faces the right nose pad 114. The left lens 116 is situated between the left temple 102 and the nose bridge 110 or the left nose pad 112. Similarly, the right lens 118 is situated between the right temple 104 and the nose bridge 110 or the right nose pad 114,

A VR scene 124 is displayed on the lenses 116 and 118. The VR scene 124 includes one VR image or a combination of two or more VR images. For example, an image of the VR scene 124 is displayed by the left lens 116 and the same image is displayed by the right lens 118. The VR scene 124 is displayed within an outer portion, of each lens 116 and 118, towards a corresponding one of the temples 102 and 104. For example, an image of the VR scene 124 is displayed on a left outer portion 128 of the left lens 116 and is also displayed on a right outer portion 130 of the right lens 118. To illustrate, the left outer portion 128 is closer to the left temple 102 compared to the left nose pad 112 or the nose bridge 110 or a left inner portion 132 and the right outer portion 130 is closer to the right temple 104 compared to the right nose pad 114 or the nose bridge 110 or a right inner portion 134. The left inner portion 132 is of the left lens 116 and the right inner portion 134 is of the right lens 118. The left outer portion 128 is located between the left inner portion 132 and the left temple 102 and the right outer portion 130 is located between the right inner portion 134 and the right temple 104.

Also, the left outer portion 128 is contiguous with the left inner portion 132 and the right outer portion 130 is contiguous with the right inner portion 134. It should be noted that the left inner portion 132 on which the occlusion layer 126 is displayed occupies a smaller surface area of the left lens 116 compared to the left outer portion 128 on which the VR scene 124 is displayed. Similarly, the right inner portion 134 on which an occlusion layer 126 is displayed occupies a smaller surface area of the right lens 118 compared to the right outer portion 130 on which the VR scene 124 is displayed.

The occlusion layer 126, such as one or more opaque VR images or one or more translucent VR images, is displayed on the lenses 116 and 118. As an example, the occlusion layer 126 is formed by one or more pixelated VR images. To illustrate, the occlusion layer 126 is formed of binary or grayscale images. As another illustration, the occlusion layer 126 does not include an image of the nose of the user, such as the user 1 or 2, wearing the VR system 101 on his/her eyes. As yet another illustration, the nose of the user is not visible to the user via the occlusion layer 126. In the illustration, the occlusion layer 126 has an intensity level, such as opaqueness or opacity or translucence, to block a view of the nose of the user from the user. The occlusion layer 126 is sometimes referred to herein as an optical occlusion layer.

The occlusion layer 126 includes one VR image or a combination of two or more VR images to occlude, such as block or hinder or obstruct, a view around and including a view of the nose of the user wearing the VR system 101 on his/her eyes. For example, an image of the occlusion layer 126 is displayed by the left lens 116 and the same image is displayed by the right lens 118. As another example, the occlusion layer 126 excludes the VR scene 124 and any portion of the VR scene 124.

The occlusion layer 126 is displayed within an inner portion of each lens 116 and 118. For example, an image of the occlusion layer 126 is displayed on the left inner portion 132 of the left lens 116 and is also displayed on the right inner portion 134 of the right lens 118. To illustrate, the left inner portion 132 is closer to the left nose pad 112 or the nose bridge 110 compared to the left temple 102 and the right inner portion 134 is closer to the right nose pad 114 or the nose bridge 110 compared to the right temple 104.

The left inner portion 132 is sometimes referred to herein as a left inner subportion of the left lens 116 and the right inner portion 134 is sometimes referred to herein as a right inner subportion of the right lens 118. Similarly, the left outer portion 128 is sometimes referred to herein as a left outer subportion of the left lens 116 and the right outer portion 130 is sometimes referred to herein as a right outer subportion of the right lens 118.

In one embodiment, the left nose pad 112 is integrated with, such as forms one unitary body with, the left rim 106. Similarly, the right nose pad 114 is integrated with, such as forms one unitary body with, the right rim 108.

In an embodiment, the left outer portion 128 is coupled to a high resolution display, and the left inner portion 132 is a low resolution display, such as a transparent liquid crystal display (LCD), an electrochromic display, or any form of transparent display capable of optical occlusion. Similarly, the right outer portion 130 is coupled to a high resolution display, and the right inner portion 134 is the low resolution display. Examples of a high resolution display, as used herein, include an LCD, a light emitting diode (LED) display, and an organic LED (OLED) display.

In one embodiment, the occlusion layer 126 having one or more transparent VR images is displayed on the lenses 116 and 118. As an example, the nose of the user is visible to the user, wearing the VR system 101, via the occlusion layer 126 showing a silhouette image of an approximation of the user's view of his/her nose. To illustrate, multiple fully set pixels, which are valued as one in a binary display or are maximum valued pixels, such as valued 255 in an 8-bit display, provide the maximum amount of transparency in the occlusion layer 126 to enable the user to view his/her nose via the occlusion layer 126.

FIG. 2 is a diagram of an embodiment of a system 200 to illustrate use of sensors 202 and 204 to facilitate generation of the occlusion layer 126. The system 200 includes the VR system 101 (FIG. 1), a portion of which is shown in FIG. 2. A front view of the VR system 101 is provided in FIG. 2. The front view is in a direction directly opposite to the rear view of FIG. 1. Examples of a sensor, as used herein, include a camera and a proximity sensor. Examples of the camera include a low resolution depth camera, a low resolution infrared camera, and a low resolution red, green, and blue wavelength (RGB) camera.

The sensor 202 is coupled in a manner, such as attached to or fixed to or embedded within, to a surface of the right nose pad 114 and the sensor 204 is coupled in the same manner to a surface of the left nose pad 112. For example, a lens of the sensor 202 faces a right portion, such as a right silhouette, of the nose and a lens of the sensor 204 faces a left portion, such as a left silhouette, the nose. The right portion of the nose is sometimes referred to herein as a right side of the nose and the left portion of the nose is sometimes referred to herein as a left side of the nose.

Each sensor 202 and 204 senses a size and shape, such as a respective one of the right and left silhouettes, of the nose of the user wearing the VR system 101 and senses a position and orientation of the VR system 101 with respect to the nose to generate electrical signals. As an example, the sensor 202 captures one or more images of the right side of the nose and the sensor 204 captures one or more images of the left side of the nose. The size and shape of the left side of the nose is an example of information regarding size and shape of the left silhouette of the nose and size and shape of the right side of the nose is an example of information regarding size and shape of the right silhouette of the nose. The information regarding the sizes and shapes of the left and right sides of the nose is captured, such as embedded, within the images captured by the sensors 202 and 204 to output the electrical signals. The electrical signals are then used to determine a size and shape of the nose or a movement of the VR system 101 with respect to the nose. Each of the size of a silhouette, such as the right or left silhouette of the nose, the shape of the silhouette, and the position and orientation of the VR system 101 with respect to the nose is an example of a parameter associated with the nose of the user. The parameter associated with the nose is sometimes referred to herein as a nose parameter.

In one embodiment, any number of sensors in addition to the sensors 202 and 204, are coupled to the nose pads 112 and 114.

In an embodiment, instead of or in addition to the sensors 202 and 204, one or more sensors are coupled to a surface, such as a bottom surface, of the nose bridge 110, to be directed towards the nose of the user.

In the embodiment in which the left nose pad 112 is integrated with the left rim 106 and the right nose pad 114 is integrated with the right rim 108, the sensor 204 is coupled in a manner, such as attached to or fixed to or embedded within, to the left rim 106 and the sensor 202 is coupled in the same manner to the right rim 108.

FIG. 3A is a diagram of an embodiment of a system 300 to illustrate dynamic sensing of the nose parameters. FIG. 3B is a diagram of an embodiment of a system 350 to illustrate generation of data of the occlusion layer 126 and display of the occlusion layer 126 besides the VR scene 124. With reference to FIG. 3A, the system 300 includes a server system 302 and the client device 304. The server system 302 further includes a processor system 306, a communication device 308, an occlusion layer 310, another occlusion layer 312, and a VR scene 314. The client device 304 includes a processor system 316, a communication device 318, a sensor system 320, a display device 322, nose parameters 324 and nose parameters 326. The system 300 further includes a computer network 328.

Examples of the client device 304 include the VR system 101 (FIG. 1). For example, an example of the client device 304 is the VR system 120 (FIG. 1) when worn by the user 1 and is the VR system 122 (FIG. 1) when worn by the user 2. As another example, the client device 304 includes a computing device, such as a game console, and the VR system 101. The computing device is coupled to the VR system 101. Examples of a processor system, as used in, include one or more microcontrollers, one or more microprocessors, one or more application specific integrated circuits (ASICs), one or more programmable logic devices (PLDs), one or more central processing units (CPU), or a combination of a CPU and a graphical processing unit (GPU). Examples of a server system, as used herein, include one or more servers that are coupled to each other to communicate with each other. Examples of the communication device, as used herein, include a network interface controller. To illustrate, the network interface controller is a network interface card (NIC).

An example of the occlusion layer 310 or the occlusion layer 312 is the occlusion layer 126 (FIG. 1). To illustrate, the occlusion layer 310 is displayed on the VR system 120 worn by the user 1 and the occlusion layer 312 is displayed on the VR system 122 worn by the user 2 (FIG. 1). An example of the VR scene 314 is the VR scene 124 displayed on the VR system 120 worn by the user 1 or displayed on the VR system 122 worn by the user 2.

Examples of the sensor system 320 include one or more sensors. To illustrate, the sensor system 320 includes the sensors 202 and 204 (FIG. 2). To illustrate, the sensor system 320 includes one or more complementary metal-oxide semiconductor (CMOS) image sensors, such as one or more cameras, of the VR system 101. The CMOS image sensors are examples of nose imaging sensors. As an example, the computer network 328 is a wide area network (WAN) or a local area network (LAN) or a combination thereof. To illustrate, the computer network 328 is the Internet or an intranet or a combination thereof. Examples of the nose parameters 324 include one or more parameters associated with the nose of the user 1 and examples of the nose parameter 326 include one or more parameters associated with the nose of the user 2. As an example, a display device, as used herein, includes high-resolution displays, such as LED displays, LCDs, or OLED displays, and includes display screens having low-resolution displays, such as E-paper displays, or electrochromic displays. To illustrate, the display device 322 includes the lenses 116 and 118 of the VR system 101 and the lenses 116 and 118 include two low-resolution displays for displaying the occlusion layer 126. The display device 322 includes two high resolution displays for displaying the virtual scene 124.

The processor system 316 is coupled to the sensor system 320, the display device 322, and the communication device 318. The communication device 318 is coupled via the computer network 328 the communication device 308. The processor system 306 is coupled to the communication device 308.

When the user, such as the user 1 or 2, wears the VR system 101, the sensor system 320 senses, such as detects, the nose parameters of the user to generate sensor signals 330. For example, the sensor system 320 senses the nose parameters 324 of the user 1 or the nose parameters 326 of the user 2 to generate the sensors signals 330 having the nose parameters 324 or 326. To illustrate, the sensor system 320 generates one or more images of the nose of the user and generates the sensor signals 330 having data of the images. As another illustration, when the client device 304 is worn by the user 1, the sensor system 320 senses the left silhouette of the nose of the user 1 to generate one of the sensor signals 330 and senses the right silhouette of the nose of the user 1 to generate another one of the sensor signals 330. Also, when the client device 304 is worn by the user 2, the sensor system 320 senses the left silhouette of the nose of the user 2 to generate one of the sensor signals 330 and senses the right silhouette of the nose of the user 2 to generate another one of the sensor signals 330.

The processor system 316 receives the sensor signals 330 from the sensor system 320 and provides data of the sensor signals 330 to the communication device 318. Upon receiving the data of the sensor signals 330, the communication device 318 applies a network communication protocol, such as a Transmission Control Protocol over an Internet Protocol (TCP/IP), to the data of the sensor signals 330 to generate communication packets and sends the communication packets via the computer network 328 to the server system 302.

Upon receiving the communication packets from the communication device 318, the communication device 308 applies the network communication protocol to obtain the data of the sensor signals 330 and provides the data to the processor system 306. The processor system 306 generates data of the occlusion layer 310 or 312 based on the data of the sensor signals 330. For example, the processor system 306 determines, from the data of the sensor signals 330, a size and shape of the left silhouette of the user, such as the user 1 or 2, and a size and shape of the right silhouette of the user. To illustrate, the processor system 306 identifies, from the data, that the left and right silhouettes of the user 1 are rough, such as jagged or uneven, in shape and large, such as long and wide, in size. As another illustration, the processor system 306 identifies, from the data of the sensor signals 330, that the left and right silhouettes of the user 2 are smooth, such as even, in shape and small, such as short and narrow, in size. As yet another illustration, the processor system 306, determines, from the data of the sensor signals 330, that the left and right silhouettes of the user are long or short in size.

Continuing with the example, the processor system 306 generates the data of the occlusion layer 310 to be displayed besides the virtual scene 314 when the nose parameters 324 are received as data within the sensor signals 330. For example, the processor system 306 generates the data of the occlusion layer 310 to be a combination of a left outline and a right outline. The left outline is determined based on the shape and size of the left silhouette of the user and the right outline is determined based on the shape and size of the right silhouette of the user. With reference to FIG. 3B, processor system 306 joins the two outlines together to form an outline 352, such as a boundary, of the occlusion layer 310. The outline 352 of the occlusion layer 310 is an example of the data of the occlusion layer 310. The outline of the occlusion layer 310 provides a size and shape of the occlusion layer 310. Moreover, the processor system 306 determines a graphics level, such as an intensity level or a color or a combination thereof, of fill-in data 354 within the outline 352 of the occlusion layer 310. The fill-in data is to be filled in within the outline 352. The data of the occlusion layer 310 does not include data generated based on graphics, such as a color or intensity or texture, of the nose of the user 1 but includes the fill-in data 354 indicating the graphics level and the graphics level is different from the graphics of the nose of the user. Also, the graphics of the nose of the user, when processed, is used to display an image of a virtual nose of the user. To illustrate, when the graphics of the nose of the user is of a first color, such as brown or white or black, the graphics level of the fill-in data 354 is of a different second color, such as red or blue or green or grey. The processor system 306 also generates an instruction 356 indicating that the data of the occlusion layer 310 is to be displayed besides the virtual scene 314 when the nose parameters 324 are received as data within the sensor signals 330. 1.

Continuing further with the example, with reference to FIG. 3A, the processor system 306 generates the data of the occlusion layer 312 to be displayed besides the virtual scene 314 when the nose parameters 326 are received as data within the sensor signals 330 in the same manner in which the data of the occlusion layer 310 is generated based on the nose parameters 324. As an illustration, the processor system 306 generates the data of the occlusion layer 312 to have an outline that matches the sizes and shapes of the left and right silhouettes of the nose of the user 2. The outline provides a size and shape of the occlusion layer 312. In the illustration, the data of the occlusion layer 312 is not generated based on graphics, such as a color or intensity or texture, of the nose of the user 2. In the illustration, the processor system 306 assigns the graphics level, such as color or intensity, to an area that is surrounded, such as bounded, by the outline of the nose of the user 2. The graphics level is different from the graphics of the nose of the user 2. The processor system 306 also generates an instruction indicating that the data of the occlusion layer 312 is to be displayed besides the virtual scene 314 when the nose parameters 326 are received as data within the sensor signals 330.

The processor system 306 provides the data of an occlusion layer, such as the occlusion layer 310 or 312, with data of the VR scene 314 and the instruction indicating that the data of the occlusion layer is to be displayed besides the VR scene 314 to the communication device 308. The communication device 308 applies the network communication protocol to the data of the occlusion layer, the data of the VR scene 314, and the instruction to generate one or more communication packets and sends the communication packets via the computer network 328 to the client device 304. The communication device 318 applies the network communication protocol to obtain the data of the VR scene 314, the data of the occlusion layer, and the instruction from the communication packets received via the computer network 328, and sends the data to the processor system 316. The processor system 316 executes the instruction to provide the data of the occlusion layer and the data of the VR scene 314 to the display device 322 to display the occlusion layer, such as the occlusion layer 310 or 312, simultaneously with and besides the VR scene 314 on the display device 322. For example, when the client device 304 is the VR system 120, the occlusion layer 310 generated according to the nose parameters 324 of the nose of the user 1 is displayed besides the VR scene 314 and when the client device 304 is the VR system 122, the occlusion layer 312 generated according to the nose parameters 326 of the nose of the user 2 is displayed besides the VR scene 314. As such, when the VR system 101 is worn by the user 2 after the user 1 wears the VR system 101, a shape and size of the occlusion layer 310 is controlled by the processor systems 306 and 316 to be modified to display the occlusion layer 312. The occlusion layer 312 has a size and shape that is a modification of the size and shape of the occlusion layer 310.

In one embodiment, the processor system 306 generates an instruction including a refresh rate of the VR scene 314 and a refresh rate of the occlusion layer, such as the occlusion layer 310 or 312. As an example, the refresh rate of the occlusion layer is less than the refresh rate of the VR scene 314. To illustrate, the refresh rate of the occlusion layer is zero and the refresh rate of the VR scene 314 is non-zero, such as 60 frames per second or 120 frames per second or 144 frames per second. The processor system 306 sends the instruction with the data of the occlusion layer and the data of the VR scene 314 via the communication device 308, the computer network 328, and the communication device 318 to the processor system 316. The processor system 316 sends the data of the occlusion layer and the VR scene 314 to the display device 322, and executes the instruction to control the display device 322 to display each of the VR scene 314 and the occlusion layer at the respective refresh rate. The display device 322 displays the VR scene 314 at the refresh rate for the VR scene 314 and displays the occlusion layer at the refresh rate for the occlusion layer. As an example, a refresh rate of a VR scene is a rate at which a first image, such as a first frame, of the VR scene is modified and controlled by the processor system 316 to display a second image, such as a second frame of the VR scene on the display device 322. The second image of the VR scene is displayed consecutively to the display of the first image of the VR scene to create an illusion of motion of one or more virtual objects or one or more virtual backgrounds or a combination thereof of the VR scene or a lack of the motion. Also, as an example, a refresh rate of an occlusion layer is a rate at which an image of the occlusion layer is modified and controlled by the processor system 316 to display a second image of the occlusion layer on the display device 322. The second image of the occlusion layer is displayed consecutively to the display of the first image of the occlusion layer.

In one embodiment, a different VR scene is displayed on lenses of the VR system 122 than the VR scene 314.

It should be noted that in an embodiment, the portions 132 and 134 do not display one or more images of the nose of the user. For example, the processor system 306 is configured not to generate data for displaying one or more images of the nose of the user from the sensor signals 330.

FIG. 4 is a diagram of an embodiment of a system 400 to illustrate an occurrence of an update of the occlusion layer with slippage of the VR system 101 (FIG. 1) on the nose of the user. The system 400 includes the computer network 328, the client device 304, and the server system 302. The processor system 316 determines whether there is a slippage of the client device 304 with respect to the nose of the user wearing the client device 304. For example, the processor system 316 determines whether there is movement of the client device 304 that is beyond a predetermined threshold. To illustrate, the processor system 316 receives the sensor signals 330 generated during a first time interval. The sensor signals 330 indicate the nose parameters, including the positions and orientations at a first time of the left and right silhouettes of the nose, of the user. The processor system 316 further receives sensor signals 402 from the sensor system 320. The sensor signals 402 are generated by the sensor system 320 during a second time interval, which occurs after the first time interval, and the sensor signals 402 indicate the nose parameters of the user, wearing the client device 302, at a second time. The processor system 316 sends data of the sensor signals 402 via the communication device 318, the computer network 328, and the communication device 308 to the processor system 306. The processor system 306 compares the data of the sensor signals 402 with the data of the sensor signal 330 to determine whether a difference between the data of the sensor signals 402 and the data of the sensor signals 330 is greater than the predetermined threshold.

An example of the difference between the data of the sensor signals 402 and the data of the sensor signals 330 is a difference between the position of the left silhouette of the user that is sensed at the second time and the position, sensed at the first time, of the left silhouette of the user. Another example of the difference between the data of the sensor signals 402 and the data of the sensor signals 330 is a difference between the orientation of the left silhouette of the user that is sensed at the second time and the orientation, sensed at the first time, of the left silhouette of the user. Another example of the difference between the data of the sensor signals 402 and the data of the sensor signals 330 is a difference between the position of the right silhouette of the user sensed at the second time and the position, sensed at the first time, of the right silhouette of the user. Yet another example of the difference between the data of the sensor signals 402 and the data of the sensor signals 330 is a difference between the orientation of the right silhouette of the user sensed at the second time and the orientation, sensed at the first time, of the right silhouette of the user.

Continuing with illustration, upon determining that the difference between the positions at the second and first times of a silhouette, such as the left or right silhouette or a combination thereof, is greater than the predetermined threshold, the processor system 306 determines that the movement of the client device 304 with respect to the nose of the user is beyond the predetermined threshold. Also, in the illustration, upon determining that the difference between the orientations at the second and first times of the silhouette is greater than the predetermined threshold, the processor system 306 determines that the movement of the client device 304 with respect to the nose of the user is beyond the predetermined threshold. On the other hand, upon determining that the difference between the positions of the silhouette at the second and first times is not greater than the predetermined threshold and the difference between the orientations of the silhouette at the second and first times is not greater than the predetermined threshold, the processor system 306 determines that the movement of the client device 304 with respect to the nose of the user is not beyond the predetermined threshold.

When the movement of the client device 304 is beyond the predetermined threshold, the processor system 316 determines that the slippage of the VR system 101 on the nose of the user has occurred. Alternatively, when the movement of the client device 304 is not beyond the predetermined threshold, the processor system 316 determines that the slippage has not occurred.

It should be noted that the positions or orientations or a combination thereof of the silhouette at the first time is an example of information regarding the positions or orientations or the combination thereof. Also, the positions or orientations or a combination thereof of the silhouette at the second time is an example of information regarding the positions or orientations or the combination thereof.

Upon determining that the slippage has occurred, the processor system 316 updates the occlusion layer that is generated based on the sensor signals 330. For example, in response to determining that the slippage is occurred, the processor system 316 generates data for displaying an updated occlusion layer 404 based on the sensor signals 402 in the same manner in which the processor system 316 generates data for displaying the occlusion layer based on the sensor signals 330. To illustrate, the processor system 316 generates data for displaying the occlusion layer 404 at a different position, such as up or down or right or left, compared to a position at which the occlusion layer generated based on the sensor signals 330 is displayed. As another illustration, the processor system 316 generates data for displaying the occlusion layer 404 at a different orientation, such as at a different angle, compared to an orientation at which the occlusion layer generated based on the sensor signals 330 is displayed. The data for displaying the updated occlusion layer 404 is sent by the processor system 306 via the communication device 308, the computer network 328, and the communication device 318 to the processor system 316. Upon receiving the data for displaying the updated occlusion layer 404, the processor system 316 sends the data to the display device 322 (FIG. 3A). The display device 322 displays the updated occlusion layer 404 instead of the occlusion layer that is displayed based on the sensor signals 330.

In an embodiment, the processor system 306 determines a statistical magnitude of the sensor signals 402 and a statistical magnitude of the sensor signals 330. The processor system 306 determines whether a difference between the statistical magnitude of the sensor signals 402 and the statistical magnitude of the sensor signals 330 is greater than a preset threshold. Upon determining that the difference is greater than the preset threshold, the processor system 306 determines that the slippage has occurred. On the other hand, in response to determining that the difference is not greater than the preset threshold, the processor system 306 determines that the slippage has not occurred. An example of a statistical magnitude of sensor signals is a maximum amplitude of the sensor signals or a mean of amplitudes of the sensor signals or a median of amplitudes of the sensor signals.

FIG. 5A is a diagram of an embodiment of a system 500 to illustrate a lighting system for providing a realistic view of the nose of the user to the user wearing a VR HMD. The system 500 includes a VR system 501, which is an example of a client device 503. The system 500 further includes the computer network 328 and the server system 302. The VR system 501 is an example of the VR system 101 (FIG. 1) and the client device 503 is an example of the client device 304 (FIG. 3A). The client device 304 includes a lighting system 506 and a driver system 508. As an example, a driver system, as used herein, includes one or more drivers, and each driver is a transistor.

On top of the left nose pad 112, a left lighting system 502 is situated and on top of the right nose pad 114, a right lighting system 504 is situated. For example, one or more light sources of the left lighting system 502 are attached to a surface of the left nose pad 112 and one or more light sources of the right lighting system 504 are attached to a surface of the right nose pad 114. The light sources of the left lighting system 502 face the left side of the nose of the user who wears the VR system 501 to emit light towards the left side and the light sources of the right lighting system 504 face the right side of the nose to emit light towards the right side. An example of a light source, as used herein, includes an LED. A combination of the left and right lighting systems 502 and 504 is shown as the lighting system 506 of the client device 503.

The processor system 306 determines a level of lighting in a VR scene 510 to be displayed on the VR system 501. For example, the processor system 306 determines that the VR scene 510 to be displayed has a light intensity level 514. To illustrate, the processor system 306 generates a statistical value, such as an average or median, from light intensity levels of all pixels of the VR scene 510 as the light intensity level 514. An example of the VR scene 510 is the VR scene 124 (FIG. 1). Upon determining that the VR scene 510 is to be displayed having the light intensity level 514, the processor system 306 provides the light intensity level 514 to the communication device 308. The processor system 306 also generates a first instruction for the processor system 316 to control the lighting system 506 to emit light having a light intensity level within a predetermined limit from the light intensity level 514. An example of the light intensity level within the predetermined limit from the light intensity level 514 is an intensity amount that is equal to the light intensity level 514. The processor system 306 provides the first instruction to the communication device 308. The communication device 308 applies the network communication protocol to the light intensity level 514 and the first instruction received from the processor system 306 to generate one or more communication packets and sends the communication packets via the computer network 328 to the communication device 318.

Upon receiving the communication packets, the communication device 318 applies the network communication protocol to the communication packets to obtain the light intensity level 514 and the first instruction from the packets and provides the light intensity level 514 to the processor system 316. The processor system 316 controls the lighting system 506 via the driver system 508 according to the first instruction to emit light having the light intensity level within the predetermined limit from the light intensity level 514. For example, the processor system 316 sends a control signal to the driver system 508. Upon receiving the control signal, the driver system 508 generates one or more current signals and provides the current signals to the lighting system 506. In response to the current signals, the lighting system 506 emits light having the light intensity level that is within the predetermined limit from the light intensity level 514. The light having the light intensity level is emitted towards the left and right sides of the nose of the user.

The processor system 306 further determines whether data of the VR scene 510 changes to data of another VR scene 512. For example, the processor system 306 determines that one or more virtual objects or one or more virtual backgrounds or the graphics level or a combination thereof within the VR scene 510 changes to determine that the data of the VR scene 510 changes to the data of the VR scene 512. To illustrate, the VR scene 510 changes to the VR scene 512 when there is a change in a state of a game played by the user who wears the VR system 501.

Upon determining that the data of the VR scene 510 changes to the data of the VR scene 512, the processor system 306 determines a light intensity level 516 in the VR scene 512 to be displayed on the VR system 501 in the same manner in which the light intensity level 514 in the VR scene 510 is determined. The processor system 306 also generates a second instruction for the processor system 316 to control the lighting system 506 to emit light having a light intensity level within the predetermined limit from the light intensity level 516. The processor system 306 sends the light intensity level 516 and the second instruction via the communication device 208, the computer network 328 and the communication device 318 to the processor system 316.

In response to receiving the light intensity level 516 and the second instruction, the processor system 316 controls the lighting system 506 via the driver system 508 to emit light having the light intensity level within the predetermined limit from the light intensity level 516 in the same manner in which the lighting system 506 is controlled to emit light having the light intensity level within the predetermined limit from the light intensity level 514. In this manner, the lighting system 506 is controlled by the processor systems 306 and 316 to emit light having different light intensity levels based on a change from the light intensity level 514 of the virtual scene 510 to the light intensity level 516 of the virtual scene 512. It should be noted that a light intensity level, as described herein, can be processed and utilized for three separate lighting colors, for example, red, green and blue (RGB) lighting colors, to fully simulate the virtual lighting falling onto the real nose of the user, viewing through the occlusion layer 126 of the portion of the lenses for the VR system 101, as in the left inner portion 132 of lens 116 and the right inner portion 134 of the lens 118 (FIG. 1).

FIG. 5B-1 is a diagram of an embodiment of a system 540 to illustrate that light from the VR scene 124 is incident via the occlusion layer 126 on the nose of the user who wears the VR system 101. When the light is incident on the nose of the user, the user sees a realistic view of the nose. The system 540 includes the VR system 101.

The processor system 306 (FIG. 3A) controls the occlusion layer 126 to change an intensity level to allow light from the VR scene 124 to be incident on the nose of the user. For example, the processor system 306 sends an instruction via the communication device 308, the computer network 328, and the communication device 318 to the processor system 316 (FIG. 3A). The instruction indicates an intensity level, such as a transparent intensity level or translucent intensity level, of the occlusion layer 126. Upon receiving instruction, the processor system 316 generates a control signal based on the intensity level and sends the control signal to the display device 322 (FIG. 3A). In response to receiving the control signal, the display device 322 displays the occlusion layer 126 at the intensity level received within the instruction. To illustrate, the intensity level is not an opaque intensity level. When the occlusion layer 126 having the intensity level is displayed, light emitted from the VR scene 124 is incident on the nose of the user.

FIG. 5B-2 is a diagram of an embodiment of a VR system 560 to illustrate transmission of light emitted from the VR scene 124 via a waveguide to be incident on the nose of the user who wears the VR system 560. The VR system 560 is an example of the VR system 101 (FIG. 1). The VR system 560 includes a left display section 562 and a right display section 564. An example of the left display section 562 is a combination of the left rim 106, the left temple 102, the left lens 116, and left portion, such as a left half portion, of the nose bridge 110 (FIG. 1) and an example of the right display section 564 is the right rim 108, the right temple 104, the right lens 116, and a right portion, such as a right half portion, of the nose bridge 110 (FIG. 1). The left portion of the nose bridge 110 is contiguous with the left rim 106 and the right portion of the nose bridge 110 is contiguous with the right rim 108.

A VR view 566 is displayed by the processor system 316 (FIG. 3A) on the left display section 562 and a VR view 568 is displayed by the processor system 316 on the right display section 564. An example of the VR view 566 is a portion of the VR scene 124 that is displayed on the left lens 116 and an example of the VR view 568 is a portion of the VR scene 124 that is displayed on the right lens 118 (FIG. 1). As an example, the VR view 568 is the same as the VR view 566. To illustrate, the VR view 568 is the same image or set of images as that of the VR view 566.

The left display section 562 includes a left waveguide 570, a left in-coupler 572, and a left out-coupler 574. As an example, the left waveguide 570 is attached to a top surface or a bottom surface of the left lens 116. Similarly, the right display section 564 includes a right waveguide 576, a right in-coupler 578, and a right out-coupler 580. As an example, the right waveguide 572 is attached to a top surface or a bottom surface of the right lens 116. As an example, a waveguide is fabricated from an optical fiber or a metal or a dielectric material. An example of an in-coupler or an out-coupler is a hole or a set of holes, such as a grating.

The left in-coupler 572 receives light emitted from the VR view 566 and the light is propagated via the left waveguide 570 to be output via the left out-coupler 574 towards, such as in a direction towards or directly towards, the left nose pad 112. The light is output towards the left nose pad 112 to focus light in a direction of the left portion of the nose of the user wearing the VR system 560. Similarly, the right in-coupler 578 receives light emitted from the VR view 568 and the light is propagated via the right waveguide 576 to be output via the right out-coupler 580 towards, such as in a direction towards or directly towards, the right nose pad 114 (FIG. 1). The light is output towards the right nose pad 114 to focus light in a direction of the right portion of the nose of the user wearing the VR system 560. The left portion of the nose is bound by the left silhouette of the nose and the right portion of the nose is bound by the right silhouette of the nose. For example, the left silhouette forms an outline surrounding the left portion of the nose and the right silhouette forms an outline surrounding the right portion of the nose.

In one embodiment, one or more out-couplers, such as the left out-coupler 574, are provided to output light emitted from the VR view 566 towards the left nose pad 112. Moreover, the processor system 306 controls an intensity level of the occlusion layer 310 (FIG. 3A) to be transparent for the user to be able to view the nose via the left inner portion 132 (FIG. 1). The processor system 306 controls the intensity level via the communication device 308, the computer network 328, the communication device 318, and the processor system 316 to display the occlusion layer 310 to be transparent on the display device 322 (FIG. 3A). Because light from the VR view 566 falls on the nose of the user and the occlusion layer 310 is transparent, a realistic view of the nose is provided to the user. Similarly, one or more out-couplers, such as the right out-coupler 580, are provided to output light emitted from the VR view 568 towards the right nose pad 114. Also, the processor system 306 controls an intensity level of the occlusion layer 310 (FIG. 3A) to be transparent for the user to be able to view the nose via the right inner portion 134 (FIG. 1) in the same manner in which the processor system 306 controls an intensity level of the occlusion layer 310 to be transparent for the user to be able to view the nose via the left inner portion 132.

FIG. 5C is a diagram of an embodiment of a system 590 to illustrate a dynamic update, such as a refresh, to the occlusion layer 126 (FIG. 1) based on a refresh rate of the VR scene 124 (FIG. 1). The system 590 includes the processor system 306.

The processor system 306 determines a graphics level 591, such as light intensity, amplitude or color or a combination thereof, of the VR scene 510 and based on the graphics level 591, determines a graphics level 592, such as light intensity, amplitude or color or a combination thereof, of the occlusion layer 126. For example, the processor system 306 calculates from graphics data of the VR scene 510, a statistical level, such as an average or median level, of the graphics data and the statistical level is the graphics level 591. To illustrate, the processor system 306 computes an average of color values or intensity values or a combination thereof of pixels of the VR scene 510 and determines the average to be the statistical level. Continuing with the example, the processor system 306 further determines the graphics level 592 to be within a predetermined range from, such as the same as or equal to, the graphics level 591. To illustrate, when the graphics level 591 is a dark color, such as black or dark grey, the processor system 306 determines the graphics level 592 to be of the same dark color or a slightly different dark color. An example of the slightly different dark color is a different intensity of black or dark grey than the graphics level 591. The different intensity of black or dark grey is within the predetermined range from the dark color of the graphics level 591.

The processor system 306 generates an instruction having the graphics level 592 of the occlusion layer 126 and the graphics level 591 of the VR scene 510, and sends the instruction via the communication device 308, the computer network 328, and the communication device 318 and to the processor system 316 (FIG. 3A). For example, the processor system 306 sends the instruction having the graphics levels 591 and 592 to the communication device 308. The communication device 318 applies the network communication protocol to the graphics levels 591 and 592 to generate one or more communication packets and sends the communication packets via the computer network 328 to the communication device 318. The communication device 318 of network communication applies the network communication protocol to obtain the instruction having the graphics levels 591 and 592 from the communication packets and sends the instruction to the processor system 316. The processor system 316 generates and sends a control signal based on the graphics levels 591 and 592 to the display device 322 (FIG. 3A). Upon receiving the control signal, the display device 322 displays the occlusion layer 126 having the graphics level 592 and displays the VR scene 124 having the graphics level 591.

The processor system 306 further determines whether a refresh of the VR scene 510 is to be performed. For example, the VR scene 510 has a refresh rate of 60 hertz (Hz) or 120 Hz or 144 Hz. The processor system 306 identifies that data of the VR scene 510 is to be refreshed to generate data of a VR scene 594. For example, the processor system 306 identifies that the data for displaying a frame, such as an image, of the VR scene 510 is to be updated to the data for displaying a frame, such as an image, of the VR scene 594 at the refresh rate. The processor system 306 determines a graphics level 596 of the VR scene 594 in the same manner in which the graphics level 591 is determined from the VR scene 510. Moreover, the processor system 306 determines a graphics level 598 of the occlusion layer 126 from the graphical level 596 of the VR scene 594 in the same manner in which the graphics level 592 of the occlusion layer 126 is determined from the graphics level 591 of the VR scene 510. In this manner, the graphics level 592 of the occlusion layer 126 is updated from the graphics level 591 to the graphics level 598 based on the refresh rate of the VR scene 510.

FIG. 6 illustrates components of an example device 600, such as a client device or a server system, described herein, that can be used to perform aspects of the various embodiments of the present disclosure. This block diagram illustrates the device 600 that can incorporate or can be a personal computer, a smart phone, a video game console, a personal digital assistant, a server or other digital device, suitable for practicing an embodiment of the disclosure. The device 600 includes a CPU 602 for running software applications and optionally an operating system. The CPU 602 includes one or more homogeneous or heterogeneous processing cores. For example, the CPU 602 is one or more general-purpose microprocessors having one or more processing cores. Further embodiments can be implemented using one or more CPUs with microprocessor architectures specifically adapted for highly parallel and computationally intensive applications, such as processing operations of interpreting a query, identifying contextually relevant resources, and implementing and rendering the contextually relevant resources in a video game immediately. The device 600 can be a localized to a player, such as a user, described herein, playing a game segment (e.g., game console), or remote from the player (e.g., back-end server processor), or one of many servers using virtualization in a game cloud system for remote streaming of gameplay to clients.

A memory 604 stores applications and data for use by the CPU 602. The memory 604 is an example of a memory device. A storage 606, such as a memory device, provides non-volatile storage and other computer readable media for applications and data and may include fixed disk drives, removable disk drives, flash memory devices, compact disc-read only memory (CD-ROM), digital versatile disc-ROM (DVD-ROM), Blu-ray, high definition-digital versatile disc (HD-DVD), or other optical storage devices, as well as signal transmission and storage media. User input devices 608 communicate user inputs from one or more users to the device 600. Examples of the user input devices 608 include keyboards, mouse, joysticks, touch pads, touch screens, still or video recorders/cameras, tracking devices for recognizing gestures, and/or microphones. A network interface 614, such as a NIC, allows the device 600 to communicate with other computer systems via an electronic communications network, and may include wired or wireless communication over local area networks and wide area networks, such as the internet. An audio processor 612 is adapted to generate analog or digital audio output from instructions and/or data provided by the CPU 602, the memory 604, and/or data storage 606. The components of device 600, including the CPU 602, the memory 604, the data storage 606, the user input devices 608, the network interface 614, and an audio processor 612 are connected via a data bus 622.

A graphics subsystem 620 is further connected with the data bus 622 and the components of the device 600. The graphics subsystem 620 includes a graphics processing unit (GPU) 616 and a graphics memory 618. The graphics memory 618 includes a display memory (e.g., a frame buffer) used for storing pixel data for each pixel of an output image. The graphics memory 618 can be integrated in the same device as the GPU 616, connected as a separate device with the GPU 616, and/or implemented within the memory 604. Pixel data can be provided to the graphics memory 618 directly from the CPU 602. Alternatively, the CPU 602 provides the GPU 616 with data and/or instructions defining the desired output images, from which the GPU 616 generates the pixel data of one or more output images. The data and/or instructions defining the desired output images can be stored in the memory 604 and/or the graphics memory 618. In an embodiment, the GPU 616 includes three-dimensional (3D) rendering capabilities for generating pixel data for output images from instructions and data defining the geometry, lighting, shading, texturing, motion, and/or camera parameters for a scene. The GPU 616 can further include one or more programmable execution units capable of executing shader programs.

The graphics subsystem 614 periodically outputs pixel data for an image from the graphics memory 618 to be displayed on the display device 610. The display device 610 can be any device capable of displaying visual information in response to a signal from the device 600, including a cathode ray tube (CRT) display, a liquid crystal display (LCD), a plasma display, and an organic light emitting diode (OLED) display. The device 600 can provide the display device 610 with an analog or digital signal, for example.

It should be noted, that access services, such as providing access to games of the current embodiments, delivered over a wide geographical area often use cloud computing. Cloud computing is a style of computing in which dynamically scalable and often virtualized resources are provided as a service over the Internet. Users do not need to be an expert in the technology infrastructure in the “cloud” that supports them. Cloud computing can be divided into different services, such as Infrastructure as a Service (IaaS), Platform as a Service (PaaS), and Software as a Service (Saas). Cloud computing services often provide common applications, such as video games, online that are accessed from a web browser, while the software and data are stored on the servers in the cloud. The term cloud is used as a metaphor for the Internet, based on how the Internet is depicted in computer network diagrams and is an abstraction for the complex infrastructure it conceals.

A game server may be used to perform the operations of the durational information platform for video game players, in some embodiments. Most video games played over the Internet operate via a connection to the game server. Typically, games use a dedicated server application that collects data from players and distributes it to other players. In other embodiments, the video game may be executed by a distributed game engine. In these embodiments, the distributed game engine may be executed on a plurality of processing entities (PEs) such that each PE executes a functional segment of a given game engine that the video game runs on. Each processing entity is seen by the game engine as simply a compute node. Game engines typically perform an array of functionally diverse operations to execute a video game application along with additional services that a user experiences. For example, game engines implement game logic, perform game calculations, physics, geometry transformations, rendering, lighting, shading, audio, as well as additional in-game or game-related services. Additional services may include, for example, messaging, social utilities, audio communication, game play replay functions, help function, etc. While game engines may sometimes be executed on an operating system virtualized by a hypervisor of a particular server, in other embodiments, the game engine itself is distributed among a plurality of processing entities, each of which may reside on different server units of a data center.

According to this embodiment, the respective processing entities for performing the operations may be a server unit, a virtual machine, or a container, depending on the needs of each game engine segment. For example, if a game engine segment is responsible for camera transformations, that particular game engine segment may be provisioned with a virtual machine associated with a GPU since it will be doing a large number of relatively simple mathematical operations (e.g., matrix transformations). Other game engine segments that require fewer but more complex operations may be provisioned with a processing entity associated with one or more higher power CPUS.

By distributing the game engine, the game engine is provided with elastic computing properties that are not bound by the capabilities of a physical server unit. Instead, the game engine, when needed, is provisioned with more or fewer compute nodes to meet the demands of the video game. From the perspective of the video game and a video game player, the game engine being distributed across multiple compute nodes is indistinguishable from a non-distributed game engine executed on a single processing entity, because a game engine manager or supervisor distributes the workload and integrates the results seamlessly to provide video game output components for the end user.

Users access the remote services with client devices, which include at least a CPU, a display and an input/output (I/O) interface. The client device can be a personal computer (PC), a mobile phone, a netbook, a personal digital assistant (PDA), etc. In one embodiment, the network executing on the game server recognizes the type of device used by the client and adjusts the communication method employed. In other cases, client devices use a standard communications method, such as html, to access the application on the game server over the internet. It should be appreciated that a given video game or gaming application may be developed for a specific platform and a specific associated controller device. However, when such a game is made available via a game cloud system as presented herein, the user may be accessing the video game with a different controller device. For example, a game might have been developed for a game console and its associated controller, whereas the user might be accessing a cloud-based version of the game from a personal computer utilizing a keyboard and mouse. In such a scenario, the input parameter configuration can define a mapping from inputs which can be generated by the user's available controller device (in this case, a keyboard and mouse) to inputs which are acceptable for the execution of the video game.

In another example, a user may access the cloud gaming system via a tablet computing device system, a touchscreen smartphone, or other touchscreen driven device. In this case, the client device and the controller device are integrated together in the same device, with inputs being provided by way of detected touchscreen inputs/gestures. For such a device, the input parameter configuration may define particular touchscreen inputs corresponding to game inputs for the video game. For example, buttons, a directional pad, or other types of input elements might be displayed or overlaid during running of the video game to indicate locations on the touchscreen that the user can touch to generate a game input. Gestures such as swipes in particular directions or specific touch motions may also be detected as game inputs. In one embodiment, a tutorial can be provided to the user indicating how to provide input via the touchscreen for gameplay, e.g., prior to beginning gameplay of the video game, so as to acclimate the user to the operation of the controls on the touchscreen.

In some embodiments, the client device serves as the connection point for a controller device. That is, the controller device communicates via a wireless or wired connection with the client device to transmit inputs from the controller device to the client device. The client device may in turn process these inputs and then transmit input data to the cloud game server via a network (e.g., accessed via a local networking device such as a router). However, in other embodiments, the controller can itself be a networked device, with the ability to communicate inputs directly via the network to the cloud game server, without being required to communicate such inputs through the client device first. For example, the controller might connect to a local networking device (such as the aforementioned router) to send to and receive data from the cloud game server. Thus, while the client device may still be required to receive video output from the cloud-based video game and render it on a local display, input latency can be reduced by allowing the controller to send inputs directly over the network to the cloud game server, bypassing the client device.

In one embodiment, a networked controller and client device can be configured to send certain types of inputs directly from the controller to the cloud game server, and other types of inputs via the client device. For example, inputs whose detection does not depend on any additional hardware or processing apart from the controller itself can be sent directly from the controller to the cloud game server via the network, bypassing the client device. Such inputs may include button inputs, joystick inputs, embedded motion detection inputs (e.g., accelerometer, magnetometer, gyroscope), etc. However, inputs that utilize additional hardware or require processing by the client device can be sent by the client device to the cloud game server. These might include captured video or audio from the game environment that may be processed by the client device before sending to the cloud game server. Additionally, inputs from motion detection hardware of the controller might be processed by the client device in conjunction with captured video to detect the position and motion of the controller, which would subsequently be communicated by the client device to the cloud game server. It should be appreciated that the controller device in accordance with various embodiments may also receive data (e.g., feedback data) from the client device or directly from the cloud gaming server.

In an embodiment, although the embodiments described herein apply to one or more games, the embodiments apply equally as well to multimedia contexts of one or more interactive spaces, such as a metaverse.

In one embodiment, the various technical examples can be implemented using a virtual environment via the HMD. The HMD can also be referred to as a virtual reality (VR) headset. As used herein, the term “virtual reality” (VR) generally refers to user interaction with a virtual space/environment that involves viewing the virtual space through the HMD (or a VR headset) in a manner that is responsive in real-time to the movements of the HMD (as controlled by the user) to provide the sensation to the user of being in the virtual space or the metaverse. For example, the user may see a three-dimensional (3D) view of the virtual space when facing in a given direction, and when the user turns to a side and thereby turns the HMD likewise, the view to that side in the virtual space is rendered on the HMD. The HMD can be worn in a manner similar to glasses, goggles, or a helmet, and is configured to display a video game or other metaverse content to the user. The HMD can provide a very immersive experience to the user by virtue of its provision of display mechanisms in close proximity to the user's eyes. Thus, the HMD can provide display regions to each of the user's eyes which occupy large portions or even the entirety of the field of view of the user, and may also provide viewing with three-dimensional depth and perspective.

In one embodiment, the HMD may include a gaze tracking camera that is configured to capture images of the eyes of the user while the user interacts with the VR scenes. The gaze information captured by the gaze tracking camera(s) may include information related to the gaze direction of the user and the specific virtual objects and content items in the VR scene that the user is focused on or is interested in interacting with. Accordingly, based on the gaze direction of the user, the system may detect specific virtual objects and content items that may be of potential focus to the user where the user has an interest in interacting and engaging with, e.g., game characters, game objects, game items, etc.

In some embodiments, the HMD may include an externally facing camera(s) that is configured to capture images of the real-world space of the user such as the body movements of the user and any real-world objects that may be located in the real-world space. In some embodiments, the images captured by the externally facing camera can be analyzed to determine the location/orientation of the real-world objects relative to the HMD. Using the known location/orientation of the HMD the real-world objects, and inertial sensor data from the, the gestures and movements of the user can be continuously monitored and tracked during the user's interaction with the VR scenes. For example, while interacting with the scenes in the game, the user may make various gestures such as pointing and walking toward a particular content item in the scene. In one embodiment, the gestures can be tracked and processed by the system to generate a prediction of interaction with the particular content item in the game scene. In some embodiments, machine learning may be used to facilitate or assist in said prediction.

During HMD use, various kinds of single-handed, as well as two-handed controllers can be used. In some implementations, the controllers themselves can be tracked by tracking lights included in the controllers, or tracking of shapes, sensors, and inertial data associated with the controllers. Using these various types of controllers, or even simply hand gestures that are made and captured by one or more cameras, it is possible to interface, control, maneuver, interact with, and participate in the virtual reality environment or metaverse rendered on the HMD. In some cases, the HMD can be wirelessly connected to a cloud computing and gaming system over a network. In one embodiment, the cloud computing and gaming system maintains and executes the video game being played by the user. In some embodiments, the cloud computing and gaming system is configured to receive inputs from the HMD and the interface objects over the network. The cloud computing and gaming system is configured to process the inputs to affect the game state of the executing video game. The output from the executing video game, such as video data, audio data, and haptic feedback data, is transmitted to the HMD and the interface objects. In other implementations, the HMD may communicate with the cloud computing and gaming system wirelessly through alternative mechanisms or channels such as a cellular network.

Additionally, though implementations in the present disclosure may be described with reference to a head-mounted display, it will be appreciated that in other implementations, non-head mounted displays may be substituted, including without limitation, portable device screens (e.g. tablet, smartphone, laptop, etc.) or any other type of display that can be configured to render video and/or provide for display of an interactive scene or virtual environment in accordance with the present implementations. It should be understood that the various embodiments defined herein may be combined or assembled into specific implementations using the various features disclosed herein. Thus, the examples provided are just some possible examples, without limitation to the various implementations that are possible by combining the various elements to define many more implementations. In some examples, some implementations may include fewer elements, without departing from the spirit of the disclosed or equivalent implementations.

Embodiments of the present disclosure may be practiced with various computer system configurations including hand-held devices, microprocessor systems, microprocessor-based or programmable consumer electronics, minicomputers, mainframe computers and the like. Embodiments of the present disclosure can also be practiced in distributed computing environments where tasks are performed by remote processing devices that are linked through a wire-based or wireless network.

Although the method operations are described in a specific order, it should be understood that other housekeeping operations may be performed in between operations, or operations may be adjusted so that they occur at slightly different times or may be distributed in a system which allows the occurrence of the processing operations at various intervals associated with the processing, as long as the processing of the telemetry and game state data for generating modified game states and are performed in the desired way.

One or more embodiments can also be fabricated as computer readable code on a computer readable medium. The computer readable medium is any data storage device that can store data, which can be thereafter be read by a computer system. Examples of the computer readable medium include hard drives, network attached storage (NAS), read-only memory, random-access memory, compact disc-read only memories (CD-ROMs), CD-recordables (CD-Rs), CD-rewritables (CD-RWs), magnetic tapes and other optical and non-optical data storage devices. The computer readable medium can include computer readable tangible medium distributed over a network-coupled computer system so that the computer readable code is stored and executed in a distributed fashion.

In one embodiment, the video game is executed either locally on a gaming machine, a personal computer, or on a server. In some cases, the video game is executed by one or more servers of a data center. When the video game is executed, some instances of the video game may be a simulation of the video game. For example, the video game may be executed by an environment or server that generates a simulation of the video game. The simulation, on some embodiments, is an instance of the video game. In other embodiments, the simulation may be produced by an emulator. In either case, if the video game is represented as a simulation, that simulation is capable of being executed to render interactive content that can be interactively streamed, executed, and/or controlled by user input.

It should be noted that in various embodiments, one or more features of some embodiments described herein are combined with one or more features of one or more of remaining embodiments described herein.

Although the foregoing embodiments have been described in some detail for purposes of clarity of understanding, it will be apparent that certain changes and modifications can be practiced within the scope of the appended claims. Accordingly, the present embodiments are to be considered as illustrative and not restrictive, and the embodiments are not to be limited to the details given herein, but may be modified within the scope and equivalents of the appended claims.

1. A wearable device comprising:
a plurality of temples having a first temple and a second temple;
a nose bridge configured to be situated on a nose of a user; and
a plurality of display portions having a first display portion and a second display portion, wherein the first display portion is located between the nose bridge and the first temple and the second display portion is located between the nose bridge and the second temple,
wherein the first and second display portions have a plurality of sub-portions configured to display one of more images of a virtual reality scene, and the first and second display portions have a plurality of additional sub-portions that are configured to display one or more images of an occlusion layer between eyes of the user and the nose of the user to occlude the nose.

2. The wearable device of claim 1, wherein the plurality of additional sub-portions are configured not to display an image of a virtual nose of the user, or not to display the virtual reality scene, or to block a view of the nose of the user, or a combination thereof.

3. The wearable device of claim 1, wherein the virtual reality scene is refreshed at a higher rate compared to a refresh rate of the occlusion layer.

4. The wearable device of claim 1, wherein the plurality of sub-portions on which the virtual reality scene is displayed include a first sub-portion and a second sub-portion, and the plurality of additional sub-portions include a first additional sub-portion and a second additional sub-portion, wherein the first sub-portion is closer to the first temple compared to the first additional sub-portion, and the second sub-portion is closer to the second temple compared to the second additional sub-portion.

5. The wearable device of claim 4, wherein the first additional sub-portion is smaller than the first sub-portion and the second additional sub-portion is smaller than the second sub-portion.

6. The wearable device of claim 1, wherein the user is a first user, wherein the wearable device further comprises:
a first rim contiguous with the nose bridge;
a second rim contiguous with the nose bridge;
a plurality of sensors coupled to the first and second rims, wherein the plurality of sensors are configured to capture first information regarding sizes and shapes of one or more silhouettes of the nose of the first user;
a communication device coupled to the one or more sensors, wherein the communication device is configured to send the first information via a computer network to a server system, wherein upon sending the first information, the communication device is configured to receive instructions having a size and shape of the occlusion layer; and
a processor coupled to the communication device, wherein the processor is configured to display the occlusion layer according to the size and shape,
wherein the plurality of sensors are configured to capture second information regarding sizes and shapes of one or more silhouettes of a nose of a second user when the second user wears the wearable device,
wherein the communication device is configured to send the second information via the computer network to the server system, wherein upon sending the second information, the communication device is configured to receive a plurality of modifications to the size and shape of the occlusion layer,
wherein the processor is configured to modify the display of the occlusion layer according to the plurality of modifications to the size and shape.

7. The wearable device of claim 1, further comprising:
a first rim contiguous with the nose bridge;
a second rim contiguous with the nose bridge;
a plurality of sensors coupled to the first and second rims, wherein the plurality of sensors are configured to capture information regarding a first set of one or more positions and one or more orientations of a plurality of silhouettes of the nose of the user at a first time and information regarding a second set of one or more positions and one or more orientations of the plurality of silhouettes at a second time;
a processor coupled to the plurality of sensors, wherein the processor is configured to determine whether there is a slippage of the nose bridge based on the first and second sets of information, wherein the processor is configured to update the occlusion layer upon determining that the slippage has occurred.

8. The wearable device of claim 1, further comprising one or more nose imaging sensors configured to generate a plurality of sensor signals, wherein the processor is configured to determine based on the plurality of sensor signals whether a difference between a plurality of magnitudes of the plurality of sensor signals exceeds a threshold, wherein the processor is configured to determine that the slippage has occurred in response to determining that the difference exceeds the threshold.

9. The wearable device of claim 1, further comprising:
a plurality of light sources configured to emit light towards the nose of the user, wherein the light emitted towards the nose is determined based on the virtual reality scene.

10. The wearable device of claim 1, wherein the one of more images of the virtual reality scene include a plurality of virtual reality images, wherein the plurality of virtual reality images include a first virtual reality image and a second virtual reality image, wherein the second virtual reality image is the same as the first virtual reality image, the wearable device comprising:
a plurality of rims including a first rim and a second rim, wherein the plurality of rims are coupled to the nose bridge;
a plurality of nose pads including a first nose pad and a second nose pad, wherein the first nose pad is coupled to the first rim and the second nose pad is coupled to the second rim;
a plurality of waveguides including a first waveguide and a second waveguide,
wherein the first waveguide is configured to receive light emitted from the first virtual reality image and guide the light towards the first nose pad, and the second waveguide is configured to receive light emitted from the second virtual reality image and guide the light towards the second nose pad.

11. The wearable device of claim 1, wherein the occlusion layer is configured to be modified to have a plurality of opacities, wherein the plurality of opacities are based on a plurality of intensity levels of lights emitted from the virtual reality scene and an additional virtual reality scene.

12. A system comprising:
a server; and
a wearable device coupled to the server via a computer network, wherein the wearable device includes:
a plurality of temples including a first temple and a second temple;
a nose bridge configured to be situated on a nose of a user; and
a plurality of display portions having a first display portion and a second display portion, wherein the first display portion is located between the nose bridge and the first temple and the second display portion is located between the nose bridge and the second temple,
wherein the first and second display portions have a plurality of sub-portions and a plurality of additional sub-portions,
wherein the server is configured to generate one or more instructions to display one or more images of a virtual reality scene within the plurality of sub-portions and to display one or more images of an occlusion layer within the plurality of additional sub-portions, wherein the occlusion layer is configured to be displayed between eyes of the user and the nose of the user to occlude the nose, wherein the server is configured to determine a plurality of display sizes of the plurality of additional sub-portions.

13. The system of claim 12, wherein the plurality of additional sub-portions are configured not to display an image of a virtual nose of the user, or not to display the virtual reality scene, or to block a view of the nose of the user, or a combination thereof.

14. The system of claim 12, wherein the virtual reality scene is refreshed at a higher rate compared to a refresh rate of the occlusion layer.

15. The system of claim 12, wherein the plurality of sub-portions in which the virtual reality scene is displayed include a first sub-portion and a second sub-portion, and the plurality of additional sub-portions include a first additional sub-portion and a second additional sub-portion, wherein the first sub-portion is closer to the first temple compared to the first additional sub-portion, and the second sub-portion is closer to the second temple compared to the second additional sub-portion.

16. The wearable device of claim 15, wherein the first additional sub-portion is smaller than the first sub-portion and the second additional sub-portion is smaller than the second sub-portion.

17. The wearable device of claim 12, wherein the user is a first user,
wherein the wearable device includes:
a plurality of sensors configured to capture first information regarding sizes and shapes of one or more silhouettes of the nose of the first user;
a communication device coupled to the plurality of sensors, wherein the communication device is configured to send the first information via a computer network to the server, wherein upon sending the first information, the communication device is configured to receive the one or more instructions and the plurality of display sizes from the server via the computer network; and
a processor coupled to the communication device, wherein the processor is configured to display the occlusion layer according to the plurality of display sizes,
wherein the plurality of sensors are configured to capture second information regarding sizes and shapes of one or more silhouettes of a nose of a second user,
wherein the communication device is configured to send the second information via the computer network to the server,
wherein the server is configured to determine a plurality of modifications to the plurality of display sizes of the occlusion layer and send the plurality of modifications via the computer network to the communication device,
wherein the communication device is configured to provide the plurality of modifications to the processor,
wherein the processor is configured to modify the display of the occlusion layer according to the plurality of modifications to the plurality of display sizes.

18. A wearable device comprising:
a nose bridge configured to be situated on a nose of a user; and
a plurality of display portions having a first display portion and a second display portion, wherein the first and second display portions have a plurality of sub-portions configured to display one of more images of a virtual reality scene, and the first and second display portions have a plurality of additional sub-portions that are configured to display one of more images of an occlusion layer between eyes of the user and the nose of the user to occlude the nose,
wherein each of the plurality of additional sub-portions is closer to the nose bridge than each of the plurality of sub-portions.

19. The wearable device of claim 18, wherein the plurality of additional sub-portions are configured not to display a plurality of images of a virtual nose of a user, or not to display the virtual reality scene, or to block a view of the nose of the user, or a combination thereof.

20. The wearable device of claim 18, wherein the user is a first user, wherein the wearable device further comprises:
a plurality of sensors configured to capture first information regarding sizes and shapes of one or more silhouettes of the nose of the first user;
a communication device coupled to the plurality of sensors, wherein the communication device is configured to send the first information via a computer network to a server system, wherein upon sending the first information, the communication device is configured to receive instructions having a size of the occlusion layer; and
a processor coupled to the communication device, wherein the processor is configured to display the occlusion layer according to the size of the occlusion layer,
wherein the plurality of sensors are configured to capture second information regarding sizes and shapes of one or more silhouettes of a nose of a second user,
wherein the communication device is configured to send the second information via the computer network to the server system, wherein upon sending the second information, the communication device is configured to receive instructions regarding a plurality of modifications to the size of the occlusion layer,
wherein the processor is configured to modify the display of the occlusion layer according to the plurality of modifications.
